(19) United States
(12) Patent Application Publication
(10) Pub. No.: US 2007/0109304 A1
(43) Pub. Date: May 17, 2007

(54) System and method for producing animations based on drawings

(76) Inventors: Royi Akavia, Miami Beach, FL (US); Douglas Call, Hollywood, FL (US)

Correspondence Address: Kenneth L. Stein;Jenner & Block, 919 Third Avenue, New York, NY, 10022, US

(21) Appl. No.: 11/281,934

(22) Filed: Nov. 17, 2005

(51) Int. Cl. G06T 15/70

(52) U.S. Cl. 345/473

(57) ABSTRACT

A method and system for providing animation services to casual users, having little or no experience in creating animations or using animation software packages. One or more individuals create one or more drawings that will serve as the basis for the animation and a storyline for the characters and other elements in the drawings. The drawings and storyline are sent to an animation services system, along with optional audio selections. At the animation services system, the drawings are opened using image processing software, parsed into a number of logical subunits, and animated using image animation software. Sound effects, music and other audible components are then added to the animation. The completed animation is then provided to the individuals and optionally posted on a website accessible through the Internet. In another aspect, the invention includes a software system for receiving requests for animation services from clients, assigning those requests to animators, and providing the completed animations to the clients.

### BACKGROUND OF THE INVENTION

Animation is of great interest to children and others and, as a result, could serve as a useful and exciting educational tool in developing creativity, teamwork, and problem solving abilities. It could also serve as an engaging and non-threatening tool in exploring a child's psychological issues.

Software packages are currently available that can be used to create sophisticated animations. Generally, however, these packages require substantial training in order to fully utilize their features and require artistic capabilities on the part of the user in order to create attractive animations. These packages can also be expensive and beyond the means and the needs of a casual user.

There is accordingly a need for convenient, inexpensive, and easily accessible animation service for casual users, such as children, having little or no experience in creating animations or with animation software packages.

### SUMMARY OF THE INVENTION

The present invention provides a system and method for providing animation services to casual users, having little or no experience in creating animations or using animation software packages. The invention is particularly well suited for use in an educational or psychological analysis program, though it is not limited to those uses.

Briefly, a client, which may be one or more individuals, first creates one or more drawings that will serve as the basis for the animation. The drawings may be created, for example, on a physical medium, such as paper or the like, using a writing or drawing implement, such as crayons, pencils, pens, markers, etc. Alternatively, the drawings may be created in digital form using, for example, a software drawing package. If the one or more drawings are created on a physical medium, they are, in one embodiment, then scanned into one or more corresponding files on a computer, using a digital scanner, thus creating a digital image of each drawing. The client also creates a storyline for the characters and other elements in the one or more drawings. The storyline may be a complete or partial story or may simply describe how the characters and other elements are to interact or how they are to appear in the animation. The storyline may be in the form of a storyboard. The storyline may be created in physical form, for example, written on paper, or in digital form, using, for example, word processing software. If created in physical form, it is, in one embodiment, then scanned into digital form using a digital scanner. The client may also create and/or select audio, such as voice or music, that is to be used in the animation.

The digital images, storyline and/or audio are then sent electronically, for example, via email, to an animation services system. Alternatively, a hardcopy of the drawings and other materials may be sent to the animation services system, and the required digital images created there. At the animation services system, the digital images are opened using image processing software, such as Adobe Photoshop. Each image is then parsed, using the image processing software, into a number of logical subunits, which may include the characters, objects and features identified in the storyline.

Once the logical subunits have been prepared, they are imported into image animation software, such as Flash MX and/or Maya. In the process, the logical subunits are converted into corresponding animation subunits, such as Flash Symbols, in the image animation software. An experienced animator then creates an animation, based on the provided storyline, using the animation subunits. This may involve, for example, creating various Flash Cells and Flash Layers to form a Flash Timeline. Sound effects, music and other audible components are then added to the animation, using, e.g., Adobe Premiere Pro.

When the animation is completed it is saved in an animation file, such as an .avi file. An email notice may then be sent to the client, informing the client that the animation is available for viewing. A private link to the movie may be automatically included in the email. From there, the animation can be downloaded from the animation services system by the client or streamed to the client. Since the file containing the animation may be quite large (e.g., over 1 GB), a compressed version of the animation file may be created for downloading and/or streaming to the client. For example, Canopus Pro-Coder may be used to create such a compressed animation file (such as a .wmv file). The animation file (e.g., the .avi file) is also stored on, for example, a DVD, using DVD creation software such as Nero 6, and sent to the client by, e.g., mail, for viewing by the client on, for example, a television set. A number of duplicate DVD's may be sent to a number of different people, as specified in the order.

The animation file may also be posted on the animation services system so that other people interested in seeing the animation may view or download it.

In another aspect, the invention includes a software system for receiving requests for animation services from clients, assigning those requests to animators, and providing the completed animations to the clients.

As described below, the present invention is particularly suited for an educational environment, in which the creation of an animation can be part of a classroom project. In this aspect of the invention, students may collaborate in creating the storyline and in drawing or otherwise creating the picture or pictures that will serve as the basis for the animation. The storyline and drawings are then sent to the animation services system, which in turn creates an animation, based on the students' ideas.

### BRIEF DESCRIPTION OF THE DRAWINGS

Additional objects and features of the invention will be more readily apparent from the following detailed description and appended claims when taken in conjunction with the drawings, in which:

FIG. 1 is an illustration of a system in accordance with the present invention;

FIGS. 2A and 2B are a block diagram illustrating a process in accordance with the present invention.

FIG. 3 illustrates an animation request form that a client can use to submit information to the animation services system in one embodiment of the present invention.

### DETAILED DESCRIPTION

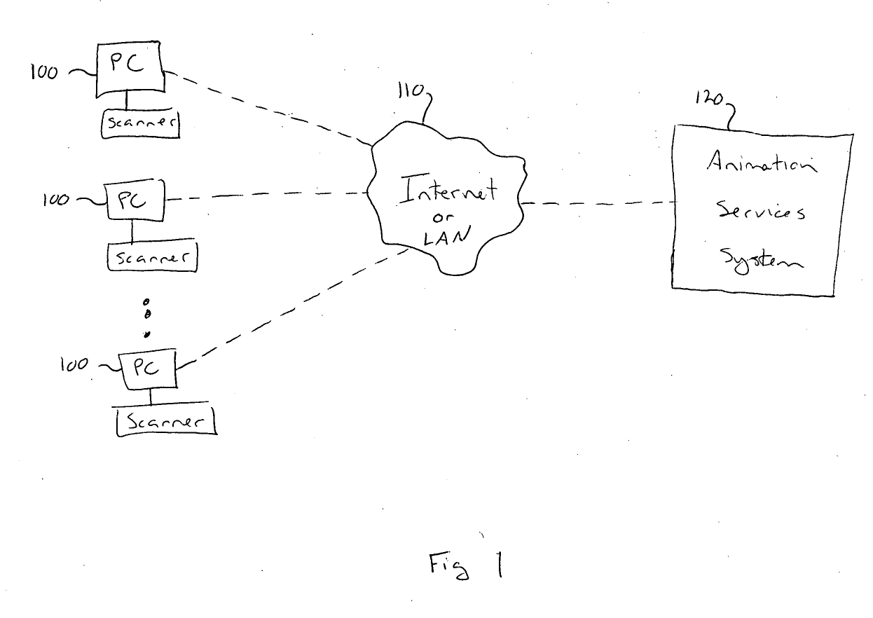

FIG. 1 illustrates an exemplary system in accordance with the present invention, in which one or more client computers 100, such as personal computers, laptop computers, etc., are capable of communicating with an animation services system 120, via a network 110, such as the Internet or a local area network (LAN). Animation services system 120 includes servers and other computers and processors, as well as storage devices, for performing the processes described below. It also includes hardware and software necessary for providing Internet-based services, as is known in the art. Animation services system 120 further includes a database system for storing information regarding orders for animation services.

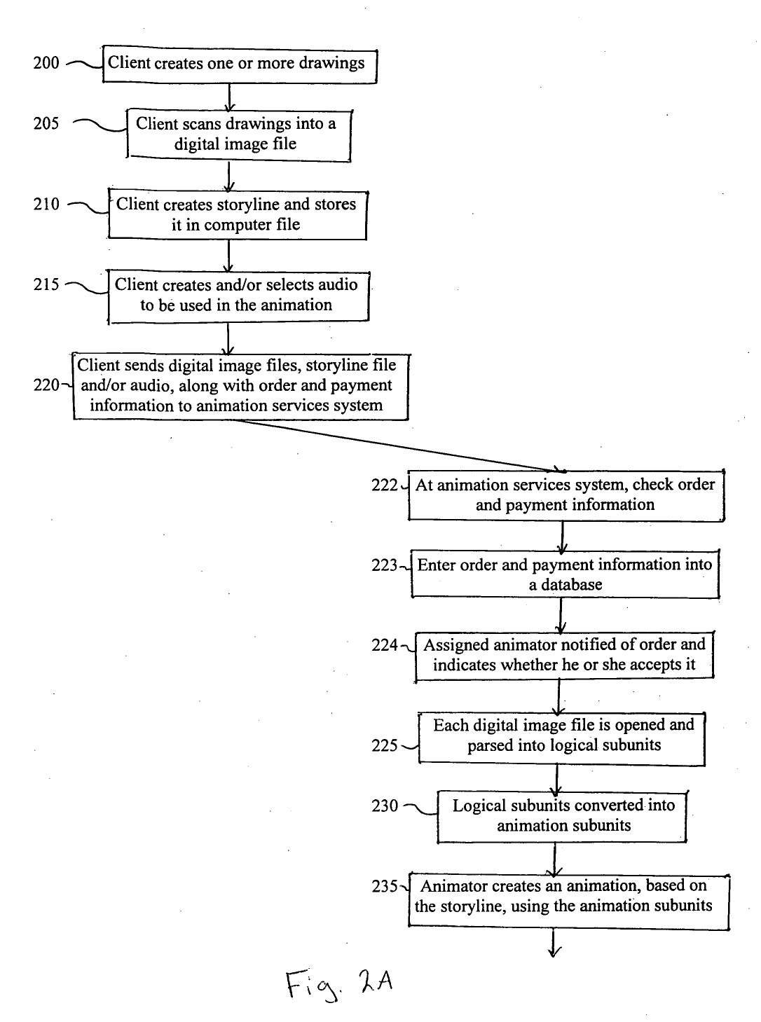

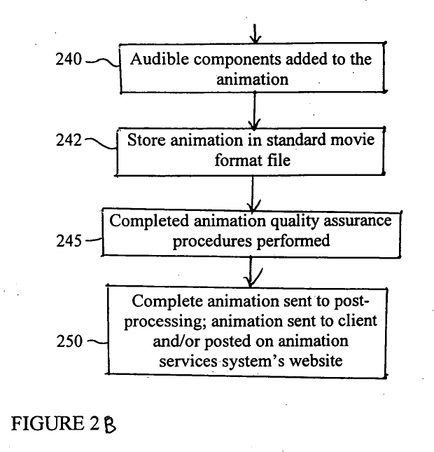

FIGS. 2A and 2B illustrate an exemplary process, in accordance with the present invention, for producing animations based on drawings. In step 200, a client creates one or more drawings that will serve as the basis for the animation. As used herein, the term “clients” refers to an individual or group of individuals, such as a class, that wishes to use the services provided by the animation services system described herein. The drawings may be created, for example, on a physical medium, such as paper or the like, using a writing or drawing implement, such as crayons, pencils, pens, markers, etc. Alternatively, the drawings may be created in digital form using, for example, a software drawing package. In step 205, if the one or more drawings are created on a physical medium, they are scanned into one or more corresponding digital image files (such as jpeg, tiff or other format image files), using a digital scanner, thus creating a digital image of each drawing. Preferably, the images should be scanned at a resolution of 250 dpi or greater. If the drawings are created directly in digital form, then step 205 may be skipped. In step 210, the client creates a storyline for the characters and other elements in the one or more drawings. The storyline may be a complete or partial story or may simply describe how the characters and other elements are to interact or how they are to appear in the animation. The storyline may be created in physical form, for example, written on paper, or in digital form, using, for example, word processing software. If created in physical form, it is then scanned into digital form using a digital scanner and stored in a computer file. In step 215, the client optionally creates and/or selects audio, such as voice or music, that is to be used in the animation.

In step 220, the client sends the digital image files, storyline file and/or audio to an animation services system, along with order and payment information, via, for example, email. Alternatively, the digital image files, storyline file and or audio may be stored on a digital medium, such as a diskette, CD, or DVD, and the medium may be sent to the animation services system.

Still alternatively, the client may send the drawings and storyline to the animation services system on a physical, non-digital medium, such as paper, in which case the animation services system can scan the drawings into digital files. The storyline may also be scanned so that it may be stored electronically along with the drawings. The drawings and storyline may alternatively be faxed to the animation services system, if the fax image quality is sharp enough to permit the further processing of the drawings described below. Audio information may also be provided in non-digital form, such as on an analog tape, in which case the animation services system can convert the analog audio into a digital audio file. In these alternative implementations, steps 205, 210 and/or 220 are modified to eliminate the storage by the client of the drawings, storyline and/or audio in digital form.

In step 222, the order and payment information is checked at the animation services system. This may include, for example, (i) verifying that an animation services agreement has been filled out and signed by an authorized person, (ii) verifying that payment information has been included, (iii) verifying that shipping and contact information for the recipients of the completed animation has been included, (iv) checking that the drawings have been included and are in a suitable form, (v) checking that a storyline or summary of the movie's theme has been included, and (vi) checking if any soundtracks have been identified or included.

In step 223, order and payment information is entered into a database through data entry software provided at the animation services system. The data entry software may provide, for example, a client master screen for entering information about the client, a client detail screen for entering information about, e.g., the children who contributed images and other input for the animation, a payment master screen for entering payment information, a payment detail screen for entering additional payment information, and an animator assignment screen for assigning the order to an animator. The entry of information into the database may be automated or performed manually. Different interfaces may be provided by the data entry software depending on the type of order. For example, the data entry software may provide different interfaces for the entry of bulk orders from school classes and other organizations and for the entry of orders from individuals placed, for example, over the Internet. The drawings, storyline and soundtracks are then provided to the assigned animator. A hard copy of all received information may also be stored.

In step 224, the assigned animator is notified, e.g., electronically, such as by email, of the order and views the animator assignment screen. The animator then indicates on the screen whether or not he or she accepts the assignment. The animator will also verify that the materials necessary to complete the animation have been provided.

If the animator accepts the assignment, in step 225, the digital images are opened by the animator using image processing software, such as Adobe Photoshop. Each image is then parsed, using the image processing software, such as by using lasso tools in Photoshop, into a number of logical subunits that are to be animated. Those subunits may include the characters, or parts of characters, and other features identified in the storyline. For example, a single character may be parsed into a number of logical subunits, such as hands, arms, legs, feet, head, torso, etc. Each parsed subunit is then saved in its own file, in, e.g., .png format, or some other image format. A background image or scenery elements may also be provided in its own drawing, or otherwise identified, and saved in its own file.

In step 230, the logical subunits are then imported into image animation software, such as Flash MX and/or Maya. In the process, the logical subunits are converted into corresponding animation subunits, such as Flash Symbols, in the image animation software. In step 235, an experienced animator then creates an animation, based on the provided storyline, using the animation subunits. This may involve, for example, creating various Flash Cells and Flash Layers to form a Flash Timeline.

For example, the animator may open Flash and import the image files, containing the logical subunits, into a library. The animator can then assemble the image subunits on the screen in one or more layers. Each layer typically contains one or more subunits that comprise a character or object that may move independently of other characters or objects in the animation. The first layer is preferably a background image or scene. As the image subunits are assembled, the animator invokes the Flash commands that convert the image subunits into animation subunits (e.g., Flash Symbols), i.e., the data format of the image subunits is converted into the format utilized by Flash. The animator may also name the animation subunits for ease of reference. The animator then animates the animation subunits, as is known in the art. For example, the animator may specify starting and ending positions and starting and ending frames for various animation subunits and instructs the animation software to automatically generate the intervening frames that show the animation subunit moving from the starting position to the ending position.

Animation software, such as Maya, may be used to provide sophisticated animation features. For example, using Maya, patterns and shading may be applied to animation objects and the objects may be animated in an automated fashion. Software tools, such as Maya, are particularly useful in connection with the present invention for making background images or scenery move (such as a river, field, sea, sky, etc.). Such animations can be rendered and stored as a sequence of image files (e.g., .png files or other format image files) that in turn can be imported into, for example, Flash, as a sequence of frames in a Flash layer.

The Flash Timeline created via the Flash animation software, in this example, is stored in Flash movie format, i.e., as a .swf file.

In step 240, the Flash Timeline is imported into video production software such as Adobe Premiere Pro. Sound effects, music and other audible components are then added to the animation. In step 242, the animation is then saved in a standard movie file format, such as in .avi format or any other such format.

In step 245, the completed animation is preferably then subject to quality assurance procedures. Those procedures may include, for example, having the animator indicate in the database record for the order that the animation is ready for a quality assurance check, sending the completed animation to a different animator or quality assurance person for review, and having that person indicate in the database record for the order whether or not the animation passed the quality assurance check.

In step 250, the animation is placed in a post-processing area. An email notice is then sent to the client, informing the client that the animation is available for viewing. A private link to the movie may be automatically included in the email. From there, the animation can be downloaded from the animation services system by the client or streamed to the client. Since the file containing the animation may be quite large (e.g., over 1 GB), a compressed version of the animation file may be created for downloading and/or streaming to the client. For example, Canopus Pro-Coder may be used to create such a compressed animation file (such as a .wmv file). The animation file (e.g., the .avi file) is also stored on, for example, a DVD, using DVD creation software such as Nero 6, and sent to the client by, e.g., mail, for viewing by the client on, for example, a television set. A number of duplicate DVDs may be sent to a number of different people, as specified in the order. If the client has agreed to permit other people to see the animation over the Internet, the animation file may also be automatically or manually posted on the animation services system so that other people interested in seeing the animation may view or download it. A client may also be separately charged for the service of having an animation posted on the animation services system.

The animation services system described herein advantageously permits the capture of data from client orders and automatically facilitates publishing movies to the Internet, emailing clients, and providing reports over the Internet to animation services system administrators of orders completed, revenue collected and order status.

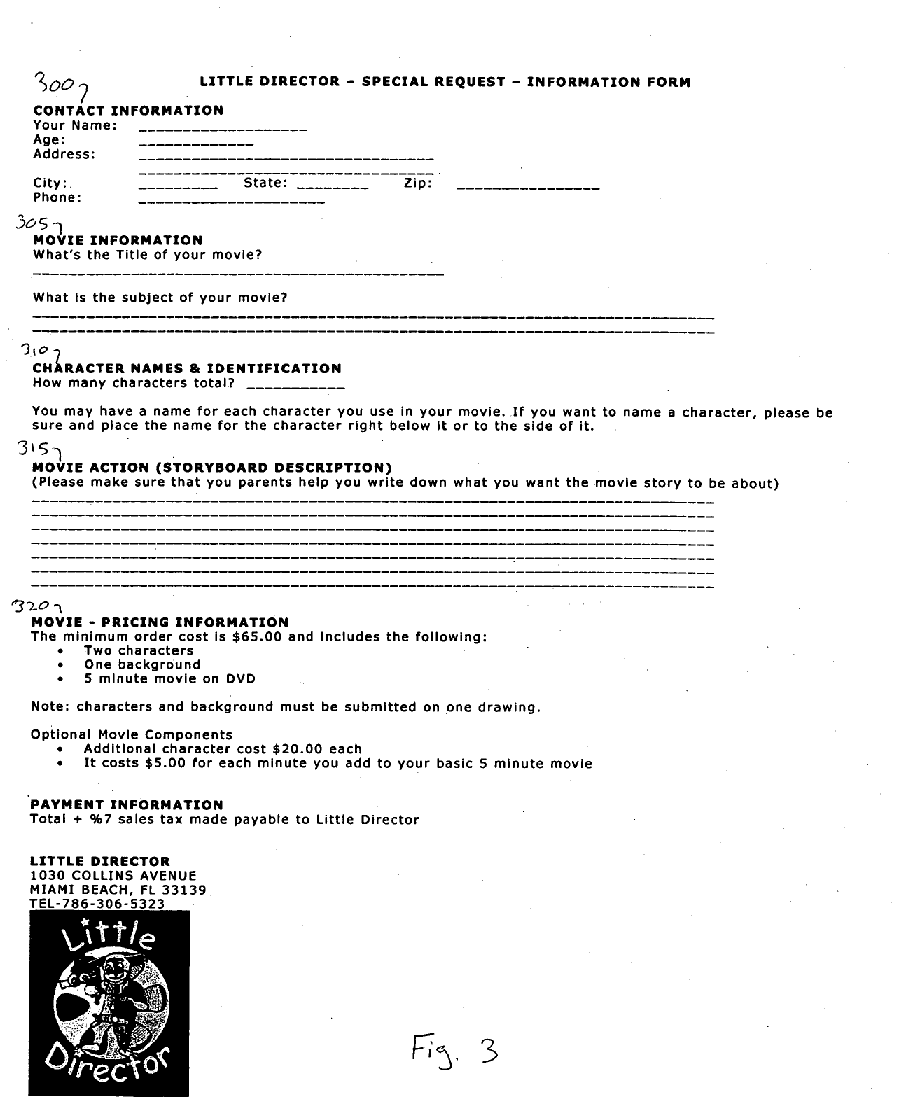

FIG. 3 illustrates an animation request form that a client can use to submit information to the animation services system in one embodiment of the present invention. Client contact information is provided in section 300. Movie information, including the title of the movie and the subject of the movie, is provided in section 305. Character information, including the number of characters and instructions for naming the characters, is provided in section 310. A description of the storyline is provided in section 315. Movie pricing information is provided in section 320. In this embodiment, the base price is for a five-minute animation, including two characters and one background. Each additional character and minute of animation costs additional money—in this example, $20 each for additional character and $5.00 for each additional minute of animation.

The present invention is particularly suited for an education environment, in which the creation of an animation can be part of a classroom project. Sample lesson plans and syllabi for the educational use of the present invention are provided below.

### Lesson Plan for Kindergarten and 1st Grade

Objective: Through the process of creative thinking and visual expression, students will learn the basic means of composing a story as a class and individually create imagery to contribute to the final product, which will be a computer animated film of their original art work.

Rationale: Students will leave having an enhanced feeling of self image and creativity provided by sharing their art in an animated movie featuring the entire classroom's input. The lesson promotes independence, as well as team spirit.

Students will gain some understanding of the process necessary for creating movies and practice brainstorming, learning to develop one concept or idea, break it down, and reassemble it to form a final product. Students will practice collaboration/cooperation, use a variety of art techniques, mediums, and skills, and gain a greater understanding of the creative process through brainstorming, creating multiple sketches, and then developing one complete, quality work of art to contribute to the collaborative project. Students will also be exposed to the possibility of creating movies as a career, and will explore other art related careers. In addition to the above, this project can be integrated with other academic subjects to create an interdisciplinary lesson which functions as an educational tool for the visual arts as well as language arts, history, science, cultural awareness, or virtually any other elementary subject.

Preparation: Read through the entire lesson plan, have enough disclaimer forms for each student, as well as materials for art production.

Procedure:

Day 1: Introduce the lesson by asking the students if they think they could make a movie. To stimulate creative thinking ask how they could do it. Call on students to express their ideas and answers. Explain that what they just did was brainstorm, and explain what brainstorming means. Ask students to brainstorm ideas for a movie that they would like to make. Guide their thinking by giving examples drawing from various experiences they have had, such as a birthday celebrations, discovering something new, or seeing something frightening. Encourage innovative and unrealistic thinking to arrive at new concepts. As the students brainstorm, write their ideas on a large sheet of paper with a marker, for the whole class to see. Try to keep students focused by only calling on a few students, because too many ideas become overwhelming and attention will be lost. This is also where the lesson could become interdisciplinary and topics being studied in other subjects may be used as a point of departure for the creation of the visual imagery for the class movie. For example, students could develop the movie about recycling or dinosaurs, relating to science topics, or the discovery of America in history.

After brainstorming, guide students in arriving at one idea to develop further as the theme of the class movie. Explain that the process for making the class movie is as follows:

1) Students brainstorm ideas and decide on one to be the main concept of their movie.

2) The teacher will create a storyboard as a plan to follow for their production.

3) Students will then create characters and backgrounds separately to be composed for the movie.

4) Imagery will be sent to the animation services system for digital formatting and computer editing, resulting in the creation of an animated movie on DVD.

Use simple language when explaining to children.

Hand out the “character” submission forms, including the disclaimer, which must be signed by a parent and returned.

Children in kindergarten and first grade are new at going to school, and are becoming acquainted with academic subjects. Students may not be aware of the parts of a story. Basically explain that they will have a beginning, middle, and end. Explain what a character is, and what a background is. Using visual aids is highly recommended.

Day 2: Prior to day 2, the teacher needs to create a simple storyboard of the student's story to use as a guide. Consider the number of students along with the number of frames. Since some students will be creating only characters, make sure that there are enough frames for students, but not too many frames and not enough students.

Begin class by explaining the meaning of a storyboard, and how this will be used to organize their movie. (A storyboard is a series of simple pictures depicting important changes of scene and action in a planned film or video production.) Show students the storyboard and explain the story with each image.

Final artworks can be created using any two-dimensional media, which can be decided on by the teacher. Some suggested mediums are crayon, colored pencil, marker, oil pastels, chalk pastels, watercolor, tempera paint, cut paper and glue, magazine collage, or mixed media.

If possible show a few minutes of a popular children's show or movie. Pause the show a few times and ask students to identify the background and describe what is in it. Then ask students to identify characters, and what they are doing. This will develop their understanding of characters and background.

BACKGROUND: Using the storyboard determine the most basic backgrounds necessary for the movie, and assign students in small groups to create those backgrounds. Explain that a background is like a place, or a setting. Help students think of what they would find in those places, so they know what to portray in their backgrounds. Visual examples, such as photographs are helpful reminders to keep students on track.

Day 3: Prior to the beginning of class organize the backgrounds to correctly portray the story.

CHARACTERS: Explain to students what the main characters are, and what they look like. Assign small groups to create images of characters, reminding them what the characters look like. Creating characters may need to be done step by step with the class as a whole as younger artists quickly move on and draw over their work once they are finished.

After characters are complete, show students the organized background, and add characters, so they can see what their movie looks like at this point.

If the teacher prefers, instead of each student creating one background, and one character separately, students may create one artwork that is part of the story, which includes both in one piece. This would most likely take one class period instead of two as described above.

Day 4: Watch the completed movie, and guide students in a discussion of the movie. Ask about their favorite parts and any changes they might make to make it better. If time allows view movies from other class periods. Present each student with a certificate and DVD of the movie.

Adaptations to this plan should be made to fit the needs of the students with regard to their age and capabilities. For older students, the teacher should challenge their creative thinking with the creation of the storyboard, and also with the complexity and quality of their artwork.

### Syllabus Plan for Kindergarten and 1st Grade

Objective: Through the process of creative thinking and visual expression, students will learn the basic means of composing a story as a class and individually create imagery to contribute to the final product, which will be a computer animated film of their original art work.

Expectations: Students will be expected to participate in class discussions, collaborate and cooperate with others to form the storyboard, create sketches for a final artwork, and complete a quality artwork to be included in the movie. Students will be expected to behave appropriately and follow normal classroom rules.

Topics/Class Schedule:

Class 1: Project introduction, expectations, hand out disclaimer forms, begin developing the story

Class 2: Discuss and show storyboard, create images of backgrounds

Class 3: Create images of characters

Class 4: View and discuss the movie, and movies from other class periods if time allows, present certificates and DVD's

Grading Policy: Students will be graded on the following items:
participation is class discussions
cooperation with others
Final Artwork:
   completed on time
   portrays the assigned subject matter
   image is a complete artwork (attention to entire image surface—though some parts may be left empty intentionally as part of the complete piece—not just forgotten)
   image shows detail and creativity

Disclaimer forms must be returned by the assigned date in order for student's artwork to be included in the animation of the movie. Each student's artwork is a necessary part of the final, whole piece. Artwork without a consent form will not be included, which will affect the quality of the whole movie, if parts are missing. Be sure to return the disclaimer forms on time.

### Lesson Plan for Grades 2, 3 and 4

Objective: Through the process of creative thinking and visual expression, students will learn the basic means of composing a story as a class and individually create imagery to contribute to the final product, which will be a computer animated film of their original art work.

Rationale: Students will leave having an enhanced feeling of self image and creativity provided by sharing their art in an animated movie featuring the entire classroom's input. The lesson promotes independence, as well as team spirit.

Students will gain some understanding of the process necessary for creating movies, practice brainstorming, learn to develop one concept or idea, break it down, and reassemble it to form a final product. Students will practice collaboration using cooperation, use a variety of art techniques, mediums, and skills, gain a greater understanding of the creative process through brainstorming, creating multiple sketches, and then developing one complete, quality work of art to contribute to the collaborative project. Students will also be exposed to the possibility of creating movies as a career, as well as explore other art related careers. In addition to the above, this project can be integrated with other academic subjects to create an interdisciplinary lesson which functions as an educational tool for the visual arts as well as language arts, history, science, cultural awareness, or virtually any other elementary subject.

Preparation: Read through the entire lesson plan, have enough disclaimer forms for each student, as well as materials for art production.

Procedure:

Day 1: Introduce the lesson by asking the students if they think they could make a movie. To stimulate creative thinking ask how they could do it. Call on students to express their ideas and answers. Explain that what they just did was brainstorm, and explain what brainstorming means. Ask students to brainstorm ideas for a movie that they would like to make. Give examples drawing from various experiences they have had, such as a birthday celebrations, discovering something new, or finding something frightening. Encourage innovative and unrealistic thinking to arrive at new concepts. As the students brainstorm, write their ideas on a large sheet of paper with a marker, for the whole class to see. This is also where the lesson could become interdisciplinary and topics being studied in other subjects may be used as a point of departure for the creation of the visual imagery for the class movie. For example, students could develop the movie about recycling or dinosaurs, relating to science topics, or the discovery of America in history.

After brainstorming, guide students in arriving at one idea to focus on as the theme of the class movie. Explain that the process for making the class movie is as follows:

1) Students will brainstorm ideas and decide on one to be the main concept of their movie.

2) The teacher will guide the students in creating a storyboard as a plan to follow for their production.

3) Students will then create characters and backgrounds separately to be composed for the movie.

4) Imagery will be sent to the animation services system for digital formatting and computer editing, resulting in the creation of an animated movie on DVD.

Hand out the “character” submission forms, including the disclaimer, which must be signed by a parent and returned.

If time allows this class period, begin developing the story, reminding students that it needs to have a beginning, middle, and end.

Day 2: Begin class by reinforcing the meaning of a storyboard, and how this will be used to organize their movie. (A storyboard is a series of simple pictures depicting important changes of scene and action in a planned film or video production.) Using one long sheet of paper (several feet) or many single sheets of paper, create a storyboard of images that visually describe the story. These will be simple sketches in each frame, or even words that convey the idea. Teachers must consider the number of students along with the number of frames. Since some students will be creating only characters, make sure that there are enough frames for students, but not too many frames and not enough students.

It is important to design the storyboard with the class, so that students learn to work together, and also understand how their original ideas will be transformed into an animated movie.

When the entire story, characters, and storyboard are complete the teacher will assign characters and backgrounds to students to draw. If there is enough time, students may begin sketching their ideas for their images. Creating the whole storyboard may take more than one class, depending on how the students work.

Day 3: Students should create sketches of their images, to be approved by the teacher.

Second and Third Grades:

Creating sketches for a final artwork may be a new concept for students, yet it teaches students to think alternatively, and not always go with the first idea they come to. Sketching is part of the creative process. Also, final artworks may look nothing like the ideas portrayed in the sketch. This is acceptable at this level and helps to get students used to working that way.

Final artworks can be created using any two-dimensional media, which can be decided on by the teacher. Some suggested mediums are crayon, colored pencil, marker, oil pastels, chalk pastels, watercolor, tempera paint, cut paper and glue, magazine collage, or mixed media. During this class period a demonstration on the use of a new material or technique, and practicing that technique or use of material may also be done. The teacher may need to give two separate demonstrations to students, one demonstration for those working on backgrounds and another for those working on characters. It will be beneficial to have students that are working on characters sit together, and those working on backgrounds sit together to avoid confusion and distraction.

Day 4: Students should use their sketches to begin creating their final artwork. The number of days needed to complete a final artwork may vary depending on the media, and the student's work ethic. Two days should be sufficient for second and third graders, and two to three days for fourth graders.

Day 5: Students should continue creating or complete their final artwork. Discuss sound with regard to the story with the students. Are there any noises that they relate to certain images, or parts of the story? Record any additional audio information that can be used to enhance their visual story.

Day 6: Organize the artwork to correctly portray the story prior to class. This may be done on the floor or in a hallway, by placing the artworks sequentially next to each other. Have the class walk past each image and edit and make any necessary changes. With any remaining time, explain that some people actually do this as their job. Ask students to brainstorm about other possible art related careers. Encourage students to think of more nontraditional jobs. Younger students may not understand some of the careers, but try to get them to understand how art is used in the career. Using images of those professionals found through Internet image searches may be helpful.

For ideas go to www.ub-careers.buffalo.edu/cdo/cartcare.htm.

Day 7: Watch the completed movie, and guide students in a discussion of the movie. Ask about their favorite parts and any changes they might make to make it better. Explain that professionals do this many times before releasing work to the public. If time allows view movies from other class periods. Present each student with a certificate and DVD of the movie.

Adaptations should be made to fit the needs of the students with regard to their age and capabilities. For older students, the teacher should challenge their creative thinking with the creation of the storyboard, and also with the complexity and quality of their artwork.

### Syllabus Plan for Grades 2, 3 and 4

Objective: Through the process of creative thinking and visual expression, students will learn the basic means of composing a story as a class and individually create imagery to contribute to the final product, which will be a computer animated film of their original art work.

Expectations: Students will be expected to participate in class discussions, collaborate and cooperate with others to form the storyboard, create sketches for a final artwork, and complete a quality artwork to be included in the movie. Students will be expected to behave appropriately and follow normal classroom rules.

Topics/Class Schedule:

Class 1: Project introduction, expectations, hand out disclaimer forms, begin developing the story

Class 2: Discuss and create a storyboard and assign students characters or backgrounds, begin sketches if time allows

Class 3: Demonstration of new media or technique, complete sketches of images, begin creating final artwork

Class 4: Begin or continue final artwork

Class 5: Complete final artwork, discuss audio

Class 6: Organize images and discuss other possibilities for art related careers

Class 7: View and discuss the movie, and movies from other class periods if time allows, present certificates and DVD's

Grading Policy: Students will be graded on the following items:
participation is class discussions
cooperation with others
completion of preliminary sketches
Final Artwork:
   completed on time
   portrays the assigned subject matter
   image is a complete artwork (attention to entire image surface—though some parts may be left empty intentionally as part of the complete piece—not just forgotten)
   image shows proper use/development of a new technique or use of material
   image shows adequate detail, creativity, and high quality craftsmanship

Disclaimer forms must be returned by the assigned date in order for student's artwork to be included in the animation of the movie. Each student's artwork is a necessary part of the final, whole piece. Artwork without a consent form will not be included, which will affect the quality of the whole movie, if parts are missing. Be sure to return the disclaimer forms on time.

The illustrative descriptions of the application of the principles of the present invention are to enable any person skilled in the art to make or use the disclosed invention. All references cited herein are incorporated by reference herein in their entirety. These descriptions are susceptible to numerous modifications and alternative arrangements by those skilled in the art. Such modifications and alternative arrangements are not intended to be outside the scope of the present invention. The appended claims are intended to cover such modifications and arrangements. Thus, the present invention should not be limited to the described illustrative embodiments but, instead, is to be accorded the broadest scope consistent with the principles and novel features disclosed herein.

What is claimed is:

1. A method of producing an animation comprising the steps of
receiving at an animation services system one or more drawings and a storyline sent by a client;
parsing the drawings into logical subunits;
converting the logical subunits into animation subunits;
creating an animation, based on the storyline, using the animation subunits; and
providing the animation to the client.

2. The method of claim 1 wherein the client comprises one or more individuals.

3. The method of claim 1 wherein the drawings and storyline are in digital files that are received electronically.

4. The method of claim 1 wherein the drawings and storyline are received via email.

5. The method of claim 1 further comprising
receiving at the animation services system audio information; and
adding audio components to the animation based on the audio information.

6. The method of claim 1 further comprising receiving at the animation services system order and payment information.

7. The method of claim 6 further comprising the steps of
creating a database entry for an order; and
entering the order and payment information into the database entry.

8. The method of claim 6 further comprising the steps of
identifying in the database entry an animator assigned to create the animation; and
sending the animator notification of the order.

9. The method of claim 8 further comprising the step of identifying in the database entry whether the animator accepts the assignment.

10. The method of claim 8 further comprising the steps of
identifying in the database entry whether the animation is completed; and
performing quality assurance on the completed animation.

11. The method of claim 1 further comprising the step of posting the animation on a website accessible through the Internet.

12. The method of claim 1 further comprising the steps of
receiving permission from the client to post the animation on a website accessible through the Internet; and
posting the animation on the website.

13. The method of claim 1 wherein the step of providing the animation to the client comprises identifying one or more individuals that are to receive the animation and providing the animation to those individuals.

14. The method of claim 1 wherein the step of providing the animation to the client comprises sending the client an email containing a link at which the animation can be retrieved through the Internet.

15. The method of claim 14 wherein a compressed version of the animation is provided at the link.

16. The method of claim 1 wherein the step of providing the animation to the client comprises storing the animation on a digital storage device and sending the digital storage device to the client.

17. The method of claim 1 wherein the client comprises a group of students.

18. The method of claim 17 wherein the one or more drawings and the storyline are created as part of a classroom project.

19. The method of claim 1 wherein one of the one or more drawings provides a background for the animation and others of the one or more drawings provide characters or objects to be animated within the animation.

20. A system for producing an animation comprising:
means for receiving one or more drawings and a storyline sent by a client;
means for parsing the drawings into logical subunits;
means for animating the logical subunits; and
means for providing the animation to the client.
